(19) United States
(12) Patent Application Publication
(10) Pub. No.: US 2004/0120494 A1
(43) Pub. Date: Jun. 24, 2004

(54) Method and system for customized call termination

(76) Inventors: Shaoning Jiang, Plano, TX (US); Probal Mukherjee, Plano, TX (US); Susan Martin, Van Alstyne, TX (US)

Correspondence Address: SLATER & MATSIL, L.L.P., 17950 PRESTON RD, SUITE 1000, DALLAS, TX, 75252-5793, US

(21) Appl. No.: 10/732,711

(22) Filed: Dec. 10, 2003

Related U.S. Application Data
(60) Provisional application No. 60/433,034, filed on Dec. 12, 2002.

(51) Int. Cl. H04M 3/42

(52) U.S. Cl. 379/210.01; 455/414.1

(57) ABSTRACT

A telecommunications system 100 includes a service control point 114 storing information indicating how a telephone call should be handled. This information includes information related to a custom ringback service. An intelligent peripheral 116 has access to at least one custom ringback clip. At least one switch 104 communicates with the service control point 114 and the intelligent peripheral 116. This switch(es) 104 is configured to route the custom ringback clip (e.g., music or video) from the intelligent peripheral 116 to a caller based upon the information related to a custom ringback service stored in the service control point 114.

This application claims the benefit of U.S. Provisional Application No. 60/433,034, filed on Dec. 12, 2002, entitled “Customized Call Termination Solutions,” which application is hereby incorporated herein by reference.

### TECHNICAL FIELD

The present invention relates generally to telecommunications, and more particularly to a system and method for customized call termination.

### BACKGROUND

To initiate a telephone call, a calling party typically dials a telephone number. The telephone system will then contact the called party and provide feedback to the calling party regarding the status of the call. For example, a busy signal will result if the called party's phone is in an off-hook condition (i.e., already engaged in a call session). If the called party's telephone is not available, the calling party may receive an error tone indicating that the call cannot be completed.

If a connection can be made, the calling party will be informed by a ringback. Ringback is an audio tone that the calling party receives after dialing a number but before a connection with the called party is completed. This signal is generated by the telephone system rather than the called party and indicates that the called party is receiving a ringing signal.

In 2002, a service became available in Korea where traditional ringback tones could be replaced with other sounds. When placing a telephone call, a caller hears a clip of music or other sound effect. The ringback tones are stored in a server at a central telecom switch. Software made by the equipment provider and/or the carrier matches the incoming calls with numbers of subscribers in a database. The ringback tone is then broadcast out as a telecommunications signal each time the subscriber is called.

### SUMMARY OF THE INVENTION

The preferred embodiment of the present invention pertains to the provision of telecommunications subscriber customizable features for call services. In particular, aspects of the invention pertain to the provision of features that can be selected by a subscriber of telecommunications services as a substitute for conventional call termination tones, commonly referred to as “call ringing” or “call ringback”, that are employed in conventional wireline and wireless communications applications.

The custom ringback tone capability provides the mechanisms to support ringback services which will enable the subscriber to select personalized music clips, announcements, audio clips, etc. to be played to the calling party in place of the existing standard ringback tone presented today. The service would provide the subscriber with the capability to select the desired personalized ringback tone.

The ringback tones will typically be clips of musical composition, announcements, audio clips, video clips, etc. that the service control point instructs the switch and an intelligent peripheral to play back to the calling party in place of standard ringing. When the custom ringback mechanisms are used to support a terminating service, the calling party will hear the custom ringback tone, music clip, or announcement chosen by the terminating party as part of their terminating IN service. For multimedia capable terminals (mobile or land line), the call termination can be in the form of multimedia, such as a music video, news clipping service, or the like. Another aspect of the invention provides for a subscriber to an enhanced call ringback service receiving the preferred call termination content (music, multimedia, etc.) when placing an outgoing call, as can occur when original a call session from a terminal associated with the subscriber's account. Such call service can be established to provide the caller's preferred call termination solution, even in instances where the called party has arranged for a specific call termination solution to be provided when the called party's telephone number is dialed.

A preferred embodiment of the present invention teaches a method for providing custom ringback in a telecommunications network. An initiation of a communication between a first party and a second party is received, e.g., at a mobile switching center. A service control point is contacted to determine a custom ringback feature. An intelligent peripheral is then connected to the first party. The intelligent peripheral provides a custom ringback to the first party based upon the custom ringback feature. While the custom ringback is being provided, the switch attempts to connect the first party with the second party.

In accordance with another preferred embodiment of the present invention, a telecommunications system includes a service control point storing information indicating how a telephone call should be handled. This information includes information related to a custom ringback service. An intelligent peripheral has access to at least one custom ringback clip. At least one switch communicates with the service control point and the intelligent peripheral. This switch(es) is configured to route the custom ringback clip (e.g., music or video) from the intelligent peripheral to a caller based upon the information related to a custom ringback service stored in the service control point.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a block diagram of a portion of a telecommunications system that can utilize aspects of the present invention;

FIG. 2 is a flowchart showing a preferred method;

FIG. 3 is a block diagram of a portion of a network to illustrate one of the other possible telecommunications networks that can utilize the present invention; and

FIGS. 4-6 are block diagrams with flow charts showing specific examples of the present invention.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a wireless telephone network. Two particular examples will be provided for a GSM network. Aspects of the invention may also be applied, however, to other communications networks including, but not limited to, other wireless protocols (e.g., CDMA, TDMA, and land-line networks, including those that use CS1 and CS2 Wireline INAP.

In one aspect, the present invention allows the operator of a telecommunication network to deploy the user selected ring back tones, music clips, and announcements to a subscriber. These techniques enhance existing intelligent network (IN) mechanisms, without violating the current and existing compliances. This functionality is applicable to both originating and terminating IN custom ringback services and can be combined with any current existing services, such as prepaid, VPN (virtual private network), or as a standalone postpaid IN based service. Combining the custom ringback mechanisms with an existing IN service can be achieved with the addition of minimal Network components, e.g., an SCP and IPIWR, and without requiring excessive Network development on the switches.

When the custom ringback mechanisms are used to support a terminating service, the calling party will hear the custom ringback tone, music clip, or announcement chosen by the terminating party as part of their terminating IN service. The custom ringback will be heard in place of the existing network-wide ringing tones currently heard today. When the custom ringback mechanisms are used to support an originating service, the calling party will hear the custom ringback tone, music clip, or announcement chosen by the originating party as part of their originating service. The custom ringback will be heard in place of the existing network-wide ringing tones ordinarily provided by the service provider.

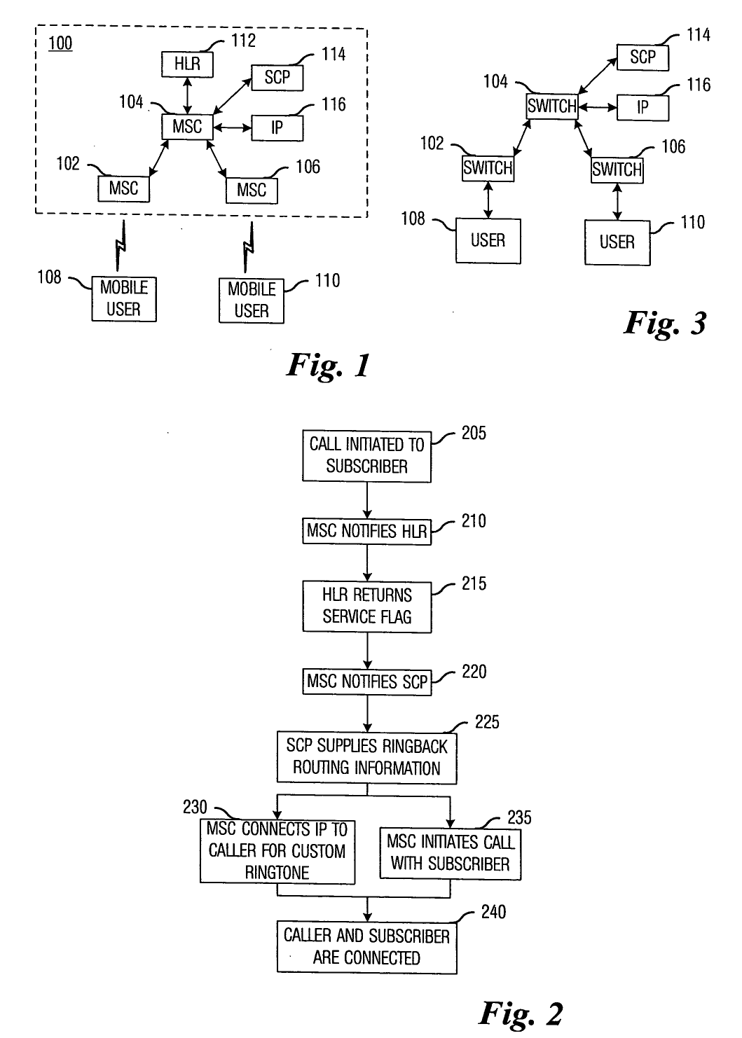

A first embodiment of the invention will now be described with respect to FIG. 1, which shows a mobile telecommunications system 100 that is capable of providing custom ringback features. While a mobile system has been chosen as the example to describe the system, it is understood that other systems, such as landline systems, could equally utilize the concepts described here.

Three mobile switching centers (MSC) 102, 104 and 106 are illustrated in the portion of the network shown in FIG. 1. These switches represent the large number of switching components that make up a communications network. In this example, MSC 102 is the switch that communicates with calling party 108 and MSC 106 is the switch that communicates with called party 110. MSC 104 represents the portion of the system that routes the call from MSC 106 to MSC 108 and also initiates the services rendered on behalf of the subscribers. These functions can be combined on a single switch or distributed over a number of switches or other components, all in a manner that is well established in the field of telecommunications.

MSC 104 is communicatively coupled to a number of components, namely home location register (HLR) 112, service control point (SCP) 114, and intelligent peripheral/intelligent voice recognition (IP/IVR) unit 116. HLR 112 typically serves as the main database of permanent subscriber information for a mobile network. Of particular relevance in this embodiment, HLR 112 stores the subscriber's preferences, including information regarding the subscription to an Originating or Terminating IN service. The SCP 114 contains subscriber information specific to custom ringback features e.g., Selected ringback clip, etc.

SCP 114 is a unit that implements a service control function. For example, SCP 114 can be implemented as a database that can be accessed to determine how a call should be handled. In this case, SCP 114 is queried by MSC 104 to provide service parameters, one of which will define the custom ringback. The SCP 114 will then instruct the MSC 104 to connect to the IP/IVR 116. When the MSC 104 and the IP 116 connection is established, the IP 116 informs the SCP 114 via the SCP 114/IP 116 interface that the IP 116 is prepared for commands. In another configuration, where there is no interface established between the SCP 114 and the IP 116, the message from the SCP 114 to the MSC 104 will contain an audio/video identifier. While not necessary, SCP 114 is typically physically separated from other components of the intelligent network in order to simplify the introduction of new services.

In this embodiment, the intelligent peripheral (IP) 116 is a unit that stores the ringback tones. The Intelligent Peripheral, IP 116 can, but does not need to, include voice recognition features and can therefore be referred to as an IP/IVR. In wireless networks, for example, pre-paid services are implemented through standard intelligent network platforms. In the absence of an IN service, one purpose of the IP/IVR is to provide for customized audio messages to the Subscriber, such as welcome to the network announcements, customer service, etc.

As will be discussed in more detail below, in this example, the IP 116 provides audio and/or video information to MSC 104, which transmits this content back to calling party 108. The SCP 114 instructs the IP 116 which audio/video clip to play to the calling party thru the defined SCP114 and IP 116 interface. In another configuration, the messaging from the MSC 104 to the IP 116 could contain the specific audio/video clip to be played. The EP 116 is shown in a different functional box as SCP 114 (and also MSCs 102, 104 and 106), but it is understood that from a physical standpoint any of these functional units can be combined. It is also understood that the functionality of any of the units can be distributed among several physical units (possibly at remote locations).

In one embodiment, IP 116 can store, or has access to another unit that stores, the custom ringtones. For example, these ringtones could be music clips from a selection of genres (e.g., classical, rock, hip hop, show tunes, or whatever). Alternatively, the subscriber could provide his or her own audio clip (e.g., “Hello, this is John. Please listen to my favorite song while my phone rings” or “Thank you for calling the Acme Widget Company where customers are our most important asset.”) IP 116 would have access to this personalized clip to provide as a custom ringback.

While the custom ringback is can be in the form of an audio clip, the present invention is not so limited. For example, IP 116 can access video clips. Subscribers could either select one of a group of available in clips or, in other embodiments, provide their own clips thru service capabilities provided by the SCP 114. Further, the ringback could be an interactive clip, such as an executable that runs on the caller's handset. For example, the caller could play a video game or access the Internet while waiting for the subscriber to answer. This embodiment could be useful for a call center that would allow the phone to continue ringing until an operator was available.

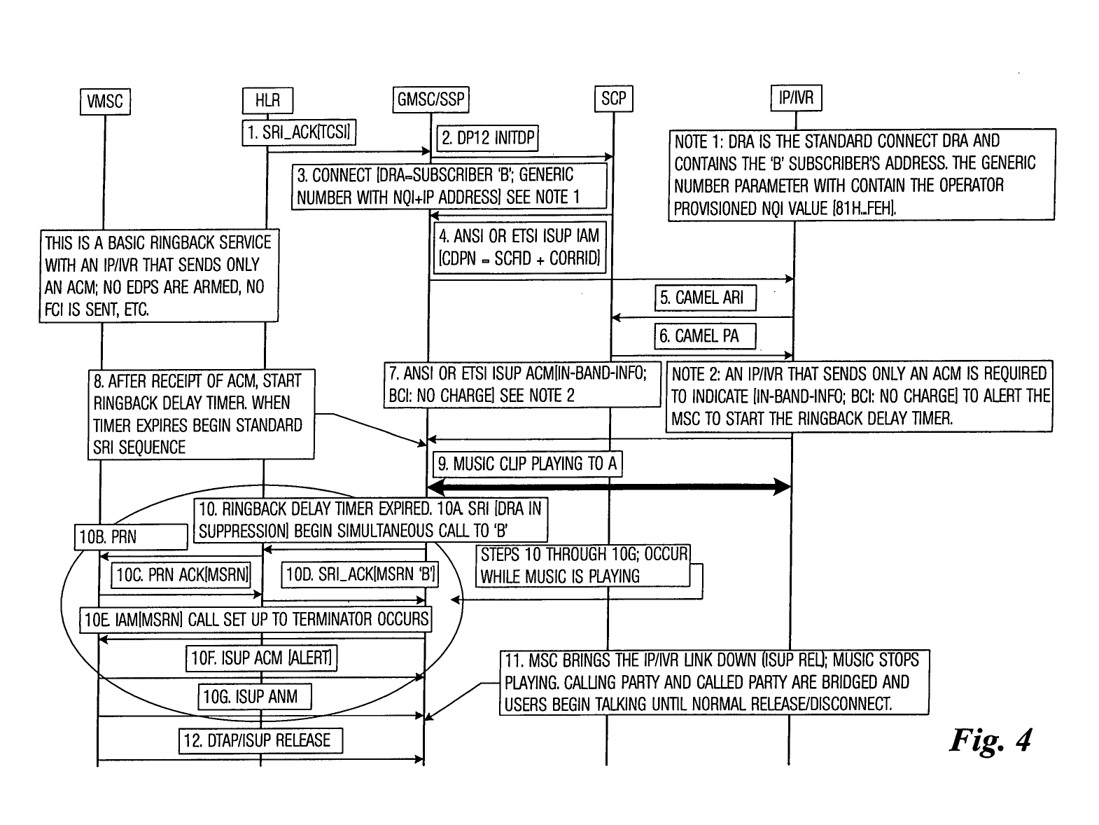

Operation of a first embodiment will now be described with respect to the flow chart of FIG. 2 along with FIG. 1. In this example, a mobile user 108 initiates a telephone call to another mobile user 110. (The example would be no different if user 108 is a landline user.) In the preferred embodiment, the user 110 has subscribed to a custom ringback feature so that caller 108 will hear a custom ringtone while the call to subscriber 110 is being initiated. In an alternate embodiment, the user 108 is the service subscriber.

To initiate the process, the user at telephone 108 dials the telephone number for subscriber 110. Accordingly, handset 108 sends a message to MSC 102, which is MSC local to the user 108's location. MSC 102 will route the call to MSC 104. In this example, it is assumed that MSC 104 communicates with each of the other devices. It is understood, however, that this assumption intentionally simplifies the system for the purposes of clarity. In reality, on one hand, a single MSC could handle all of the communications, while on the other extreme, the communications could be routed through a number of switches.

The MSC 104 contacts HLR 112, which performs a database look-up for user 110 and returns a service flag to the MSC 104. The service flag provides a number of pieces of information including whether the user 110 has subscribed to a custom ringtone feature. This communication is preferably done through standard signaling such as through SS7 messages.

Assuming that user 110 is a service subscriber, MSC 104 will send a message to SCP 114. This message is preferably a standard IN message as opposed to a hard link. In other words, in the preferred embodiment, the call is not routed through SCP 114.

In response to the inquiry from MSC 104, SCP 114 sends back a standard response indicating where to route the call. This message includes a number of parameters including a number of related elements. One of these elements within the defined parameters can be used to indicate the details of the custom ringback. In a commercial system, a number of elements in defined parameters are defined by industry standard while other elements are left undefined. In the preferred embodiment, the system is programmed to use one of these undefined elements within defined parameters. The particular element parameter will typically be defined by the service provider (e.g., the entity that operates network 100) based upon a number of factors. The use of the defined parameters to transport custom information through one of the undefined elements of the defined parameter does not disrupt the inter-vendor inter-operability across the standard interface because a new parameter is not introduced.

MSC 104 receives the message from SCP 114 and, based on the contents, sends a message to IP 116. As with SCP 114, the messaging between MSC 104 and IP 116 is preferably standard message (e.g., SS7 messages). The message from MSC 104 to IP 116 conveys information regarding the custom ringtone. For example, IP 116 may store a number of audio clips. If so, MSC 104, based upon the information received from SCP 114, will instruct IP 116 as to which of these clips will be played.

The IP 116 receives the message from MSC 104 and generates the custom ringtone. This ringtone will be transmitted from EP 116 to MSC 104 from where it can be routed back to caller 108. In one embodiment, MSC 104 includes a timer, which is preferably initiated by information in the message from SCP 114. The timer may also be standardized for the entire network thru Operator provisioning. MSC 104 will play the custom ringtone until the timer expires. After the timer expires, MSC 104 will continue to play the custom ringtone and simultaneously initiate the connection with subscriber 110. The purpose of the timer is to ensure a minimum amount of time the audio/video clip plays without exhausting network timers.

In the preferred embodiment, the custom ringtone is a music (or other audio) clip that is selected from a number of options stored on the IP 116. In other embodiment, the ringtone could be a video clip, which may or may not also include audio, or an interactive executable such as a game or a quiz, as examples. In addition, the ringtones can be unique to the particular subscriber and may be based upon time of day, day of week, time of year, calling party number, or other factors. For example, the subscriber could have access to a storage unit (not shown) where the subscriber stores a custom ringtone (e.g., a 60 second advertisement clip or an individually recorded greeting). For example, the storage unit could be accessible via the Internet. The message from MSC 104 would provide an address to IP 116 indicating where this unique clip is stored. IP 116 could then access the unique ringtone and provide it to MSC 104.

When the connection with called party 110 is complete, the custom ringtone would typically be disconnected. The network would then connect parties 108 and 110 so that the communication could commence. Alternatively, the call termination/custom ringtone could be extended into at least a portion of the completed call, should such be desired. This could be advantageous in instances where interactive content is provided as the call termination solution. If standard telephony announcements are to be played as per government regulations, such as Call Forwarding announcements, the custom ringtone would be disconnected, the announcement played, then call termination follows standard telephony.

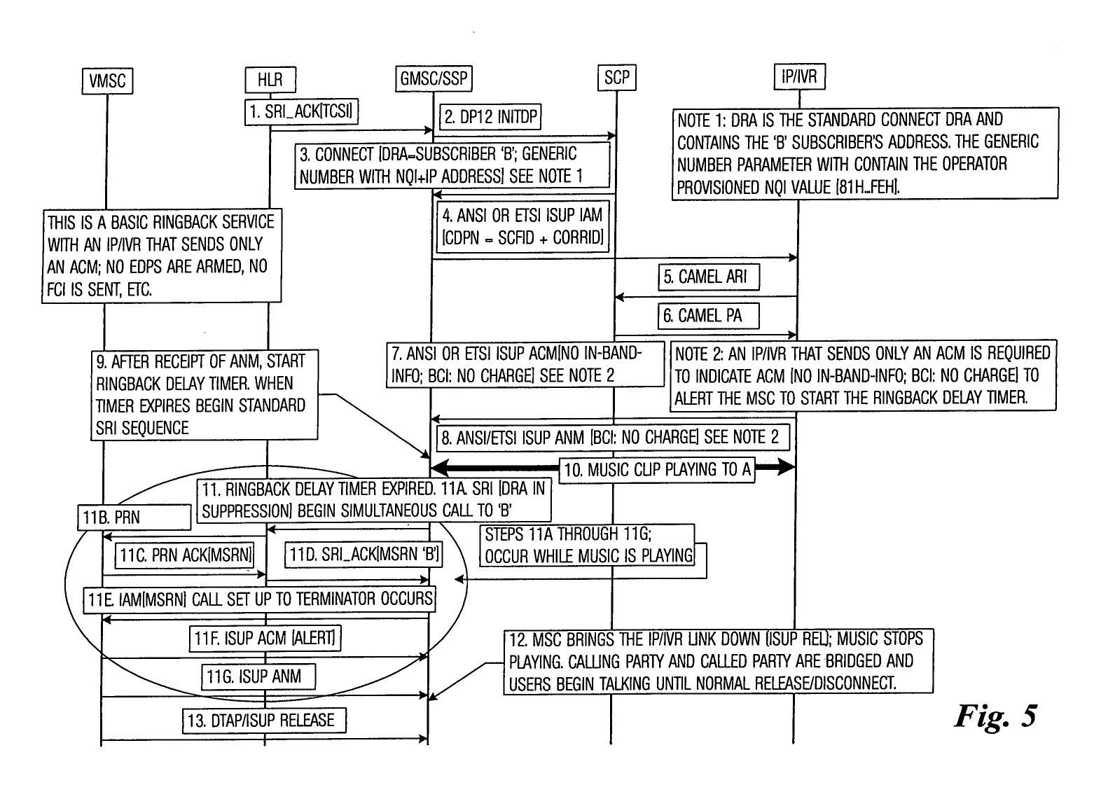

FIG. 3 provides a portion of a landline network that utilizes aspects of the present invention. As shown in the figure, the most fundamental block diagram changes little when concepts of the present invention are implemented in a landline system rather than a wireless system. Comparing FIG. 3 with FIG. 2, the HLR 112 is not needed with a landline system. In addition, switches 102, 104 and 106 are used in place of MSCs 102, 104 and 106.

Operation of the system of FIG. 3 is similar to that of FIG. 2. Switch 104 is informed of a call from user 108 to user 110. The switch 104 notifies the SCP 114, which in turn supplies ringback routing information. Switch 104 responds by connecting IP 116 to caller 108 for a custom ringtone and also initiates a call with caller 110. When caller 110 picks up, the users 108 and 110 are connected.

A more detailed example of an implementation of the present invention will now be discussed. In this example, the network 100 is a GSM network that utilizes the CAMEL standard. The CAMEL standard is a superset of the CS1 INAP standard for Wireless, which was used, as a base, the Wireline INAP standard. The CS1 INAP standard was used as a guideline to provide IN based services to Wireless customers. Because it was a guideline, each SCP and MSC vendor implemented the standard in their own proprietary manner resulting in inter-vendor incompatibilities. This inter-vendor incompatibilities prevented the Subscribers from accessing their IN based services when they were outside their home network, i.e. roaming outside their own country. As a result, the standard body defined an IN standard which defined not only the interface, but also the implementation for all the nodes involved in the service. This IN standard is called CAMEL and with CAMEL international roaming with IN based services and minimal Inter-operability Testing (IOT), became a reality for many operators.

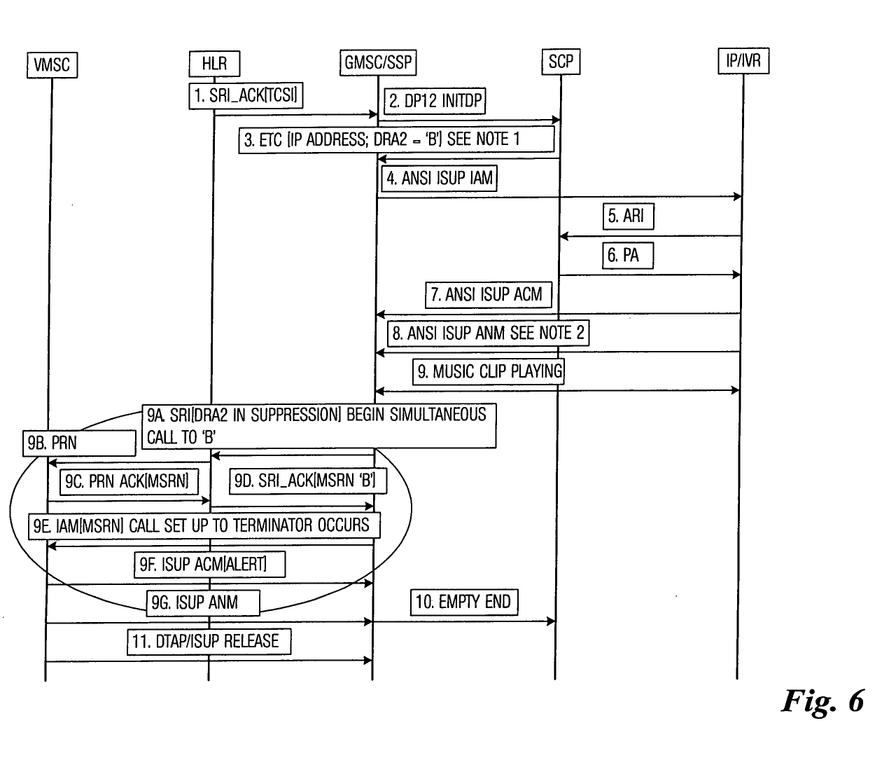

The first embodiment to be discussed implements custom ringback via a solution referred to as the CONNECT solution. After some discussion, two examples will be described with respect to FIGS. 4 and 5. The CONNECT solution is most suitable for supporting a combination PrePaid/Custom Ringback Service. This solution is applicable the supporting a Postpaid Custom Ringback service as well. The CONNECT solution allows the SCP to take advantage of the IN mechanisms which allow the service to monitor the call once the Calling and Called party have been bridged.

The CONNECT solution provides the option for the SCP to monitor the call for PrePaid Subscribers via an IN message such as the Request Report BCSM Event (RRBE) with Event Detection Point (EDP) of Answer/Disconnect set, or for PostPaid subscriber to send the RRBE with only Answer set.

For the ANSI market, the Embedded scfID and corrID should be part of the called party number in any ISUP IAM (incoming address message), or TUP LAI message. The Generic Number allows the specification of an Additional Calling Party Number. The standards define a reserved range of NQI IE values 80-FE (HEX). The digits in the Generic Number will be the embedded SCHDI/CORRID for the IP/IVR providing the personalized ringback tones. The information in the IP Address of the Generic Number Parameter is used by the MSC to route to the IP/IVR. The IP Address digits are also used by the IP/IVR for use in the ARI (Assist Request Instructions) Message. The digit sequence should be agreed upon between the SCP and IP/IVR in order to allow the IP to distinguish between the SCFIF and CORRID without explicit delimiters. This agreement should be made between the SCP and the IP/IVR. The MSC translations will use 123456 to do the translation to an external IP or IVR. In this example, 123 and 456 will be scfID and corrID address that the external IP or IVR box can use for ARI query to the SCP.

For the ETC solution, for an ITU/ETSI V3 ISUP link to external IP or IVR, the ETC operation can send down scfID and corrID in explicit format. The ISUP IAM supports the two parameters separately; embedded format is not required for ITU/ETSI V3 ISUP trunk. The DRA will contain the digit string necessary to route the call to the IP/IVR. The MSC translations will use 123456 to do the translation to an external IP or IVR. In this example, 123 and 456 will be scfID and corrID address that the external IP or IVR box can use for ARI query to the SCP.

When implemented with an MSC that is presently available from Nortel Networks, the ringback tone mechanisms do not require additional or enhancements to existing Nortel Networks' MSC and/or HLR hardware. However, to support the entire ringback tone solution across the network, there is a direct dependency on the SCP and IPIIVR. The SCP and IP/IVR requirements will now be discussed.

Looking at the SCP first, the MSC/SSP (service switching point, which is MSC software that enables IN services) and the SCP ringback service will be configured to support the CAMEL P2 Generic Number parameter with an NQI value in the CONNECT operation to provide the Ringback Tone mechanisms as follows:

CONNECT [DRA=Subscriber Address ‘B’; Generic Number=NQI:IP Address]

In this operation, DRA (destination routing address) is the standard DRA parameter of the CONNECT operation. It contains the address of Subscriber ‘B’ for the MSC to use on the second SRI and for call completion. The Generic Number allows the specification of an Additional Calling Party Number. The standards define a reserved range of Number Qualifier Identifier (NQI) IE values of 80-FE (HEX). The digits in the Generic Number will be the embedded SCFID/CORRID for the IP/IVR providing the personalized RingBack Tones. The NQI value will be configurable via an MSC configurable value. On a Nortel MSC, this configurable value is an Office Parameter. The MSC/SSP will provide the Ringback mechanisms when the CONNECT NQI value equals the NQI value in this parameter. The default NQI value will be ‘$’. Table 1 shows a generic number parameter field. This table is taken from ITU-T Q.763, namely FIG. 26 of that specification.

TABLE 1

| | | | | | | | |
|---|---|---|---|---|---|---|---|
| 8 | 7 | 6 | 5 | 4 | 3 | 2 | 1 |

| 1 | Number qualifier indicator | | | |
|---|---|---|---|---|
| 2 | O/E | Nature of address indicator | | |
| 3 | NI | Numbering plan indicator | Address presentation | Screening indicator |
| | | | restricted indicator | |

| | | |
|---|---|---|
| 4 | 2nd address signal | 1st address signal |
| . | . | . |
| . | . | . |
| . | . | . |
| m | Filler (if necessary) | nth address signal |

While not necessary in a general solution, when using existing Nortel equipment, the SCP should send the CONNECT in a CONTINUE package. The information in the IP Address of the Generic Number Parameter is used by the MSC to route to the IP/IVR. This information is also used by the IP/IVR for use in the ARI (Assist Request Instructions) Message. The digit sequence should be agreed upon between the SCP and IP/IVR in order to allow the IP to distinguish between the SCHID and CORRID without explicit delimiters. This agreement is desired, as special hex digits to explicitly identify the SCFID and CORRID are not supported in the Generic Number address.

The embedded scfID and corrID should be part of the called party number in any ANSI ISUP and/or ETSI ISUP IAM message. The ISUP CdPN limitation is 24 digits, thus the scfID and corrID should not exceed this ISUP limit. The address in the Generic Number parameter will be mapped to the CdPN of the outgoing ANSI/ETSI IAM sent to the IP/IVR. The MSC translations will need to be provisioned to do the translation to an external IP or IVR.

The SCP should embed the SCP/CORRID digits in the Generic Number SCFBD/CORRID for the IP/IVR providing the personalized RingBack Tones. This information is needed by the IP/IVR for use in the ARI (Assist Request Instructions) Message. The digit sequence needs to be agreed upon between the SCP and IP/IVR in order to allow the IP to distinguish between the SCFID and CORRID without explicit delimiters. This agreement is should be made because special hex digits to explicitly identify the SCFID and CORRID are not supported in the Generic Number address.

When using existing Nortel Networks equipment, the NQI value will be configurable via an Office Parameter in Table OFCVAR (a Nortel provisioning tool) on the Nortel Networks MSC. The MSC/SSP will provide the Ringback mechanisms when the CONNECT NQI value equals the NQI value in this parameter. The value is a single value in the range of 80H-FEH with a default of ‘$’. The value provisioned on the MSC must correspond to the NQI value the SCP will send to invoke the Ringback mechanisms on the MSC.

The impact of a special NQI in Generic Number will now be discussed. The custom usage of the NQI value in this Custom Ringback solution is not compatible with a Custom Ringback Service that modifies the Subscriber's Calling Line Identification. There is no impact on GSM CLI.

The SCP should indicate Suppression of Announcements (SoA) in the CONNECT message to prevent the Terminator's serving MSC from playing the SoA controlled RANNs (recorded announcements) for subscribers, as defined in the CAMEL standards. The SoA optional parameter does not control Call Progress Announcements played at the Terminator's serving MSC or Treatment Announcements played at the Originator's serving MSC.

For data/fax calls, the SCP should not instruct the MSC to invoke the custom ringback capabilities. Much like the SCP should not play tones or warnings for data/fax calls because they require a voice path, the same applies to the Ringback Service providing audio/video clips.

The situation with call forwarding will now be discussed, where it is assumed that ‘C’ is a ringback subscriber who receives a call from party ‘A’ through party ‘B’ (A→B; B→C). If ‘C’ is a ringback subscriber, the SCP should not direct the MSC to play the personalized Ringback Tones for ‘C’ unless the system includes a mechanism to ensure that A will hear C's custom ring-tone. In the preferred embodiment, the MSC would not send CONNECT [DRA; Generic Number]. The DP12 InitDP for ‘C’ will indicate CF has occurred: CdPN=C; CgPN=A; RedirPartyID=B. The SCP can use this unique set of information in the DP12 InitDP to make the determination not to play music. In other embodiments, this feature could be added.

The IP/IVR will now be considered. In a first case, the IP/IVR sends an address complete message (ACM) only. In this case, the ACM should contain the information [In-Band-Info; BCIL No Charge] (where BCI is Backward Call Indicator). Here the MSC should to be able to know whether or not to wait for an ANM (Answer Message, which is an ISUP message).

In a second case, the IP/IVR sends an ACM followed by ANM. In this case, the MSC should to be able to know whether or not to wait for an ANM. For those IP/IVRs that send an ACM message followed by an ANM message, the ACM should contain the information [NO In-Band-Info; BCIP No Charge] and the ANM should contain the information [BCI: No Charge]. The MSC/SSP will not report Answer to the SCP and the MSC will not start the AC/ACR timer when BCI=‘No Charge’.

Further, the IP will need to support the Ringback Tone requirement. The SCP and the IP will need to support the proper CAMEL Messaging in order to mutually identify the selected personalized Ringback Tone. The Ringback Tones will be clips of musical composition, announcements, audio clips, video clips, interactive executables, etc. that will be played back to the Calling Party.

The Embedded scfID and corrID should be part of the called party number in any ANSI ISUP and/or ETSI ISUP IAM message. The ISUP CdPN limitation is 24 digits, thus the scfID and corrID should not exceed this ISUP limit. The address in the Generic Number parameter will be mapped to the CdPN of the outgoing ANSI/ETSI LAM sent to the IP/IVR. The MSC translations will need to be provisioned to do the translation to an external IP or WR.

The SCP should embed the SCP/CORRID digits in the Generic Number SCFID/CORRID for the IP/IVR providing the personalized RingBack Tones. This information is needed by the IP/IVR for use in the ARI (Assist Request Instructions) Message. The digit sequence should be agreed upon between the SCP and IP/IVR in order to allow the IP to distinguish between the SCFID and CORRID without explicit delimiters. This agreement is desired because special hex digits to explicitly identify the SCFID and CORRID are not supported in the Generic Number address.

Two specific examples of operation of a GSM network with CONNECT Ringback Support will be described with respect to FIGS. 4 and 5 below. FIG. 4 shows an example of a basic Ringback service. In this example, the IP/IVR sends an ACM [In-Band-Info; BCI: No Charge] only. No EDPs (event detection points, which are one of the IN parameters) are armed. If the MSC is required to capture service specific billing, the SCP will need to send an FCI (Furnish Charge Information). The FCI information would be appended to the corresponding CDR (Incoming Trunk CDR) as Module Code 023.

Referring now to FIG. 4, the steps of a particular embodiment will now be described.

Step 1: Caller A calls subscriber B. The call is routed to the GMSC (gateway mobile switching center), where the standard GSM SRI (send routing information, which is a GSM MAP message) from the MSC to the HLR is sent. The response is SRI-ACK, which returns the ‘B’ Subscriber's CAMEL P2 T-CSI.

Step 2: The GMSC triggers Terminating IN at DP12 and sends an InitDP to the SCP.

Step 3: The SCP sends a CONNECT with the standard DRA containing B's and the Generic Number contains an NQI value to allow the MSC/SSP to recognize the call needs to support the Ringback Service mechanisms. Details on the special Ringback CONNECT Operation were discussed above.

Step 4: The MSC routes the call to the IP/IVR over ANSI/ETSI ISUP via IAM (incoming address message, which is an ISUP message). The Embedded scfID and corrID should be part of the called party number in any ANSI/ETSI ISUP IAM message. The maximum generic number digit length supported in the CAMEL P2 Connect Operation is 16 digits as per specifications. (The maximum generic number length is 11 bytes and 3 bytes are used for header information leaving 8 bytes or 16 digits.)

Steps 5-6: The IP/IVR sends an ARI (Assist Request Instruction, which is an IN message between the EP/IVR and the SCP) to the SCP. The SCP sends a PA (Play Announcement, which is an IN message between the IP/IVR and the SCP) to the IP/IVR identifying which personalized Ringback to play. Other messaging between the IP/IVR and SCP can be used. The preferred embodiment utilizes standard CAMEL messages.

Step 7: IP/IVR sends the MSC an ACM [In-Band-Info; BCIP No Charge]. Details on the MSC's handling of this message are discussed above.

Steps 8-9: After the ACM is received from the IP/IVR, the MSC starts the Ringback Delay Timer. When the Ringback delay timer expires, the MSC begins the standard GSM SRI sequence. The timer feature is optional. It's purpose is to ensure the ringback tone is played for a minimum amount of time.

At this point, music is playing. Personalized Ringback is played to ‘A’ until ‘B’ answers or the music clip ends. Steps 10 thru 10g occur simultaneously.

Step 10: While the music is playing, the Ringback Delay Timer expires indicating to the MSC to begin the SRI sequence and to continue standard GSM routing the call to the terminator.

Step 10a: SRI for the DRA, which is the ‘B’ party. Following the standard procedure, this SRI query suppresses IN (T-CSI Suppression) that is the HLR will not send back the T-CSI for ‘B’ as it did in the first SRI-ACK.

Step 10b: HLR sends PRN (Private Roaming Number, which is a GSM MAP message) to the VMSC to get the MSRN for ‘B.’

Step 10c: PRN-ACK is returned with the MSRN (Mobile Subscriber Routing Number, which is a MAP parameter) for ‘B.’

Step 10d: SRI-ACK with MSRN for ‘B’ is sent to the GMSC.

Step 10e: The GMSC routes the call to ‘B’ over ANSI/ETSI ISUP using the MSRN received from the HLR.

Step 10f: The VMSC sends an ACM Alert to the GMSC.

Step 10g: The VMSC sends ANM to the GMSC.

Step 11: When Answer has occurred, the MSC will release the IP/IVR link, e.g., by sending the IP/IVR an ISUP RELEASE, and bridge the calls so that ‘A’ and ‘B’ are talking. The call then continues as a normal voice call.

Step 12: Called party ‘B’ ends the call and the VMSC sends an ISUP Release to the GMSC.

The second example discussed above will now be discussed with respect to FIG. 5. As before, this is an example of a basic Ringback service. The IP/IVR sends an ACM [No In-Band-Info; BCIP No Charge] followed by an ANM [BCIP No Charge]. No EDPs are armed. If the MSC is required to capture service specific billing, the SCP will need to send an FCI. The FCI information would be appended to the corresponding CDR as Module Code 023. Each of the steps will now be described.

Step 1: As before, party A calls party B. The call is routed to the GMSC, where the standard GSM SRI from the MSC to the HLR is sent. The response is SRI-ACK, which returns the ‘B’ Subscriber's CAMEL P2 T-CSI.

Step 2: The MSC triggers Terminating IN at DP12 and sends an InitDP to the SCP.

Step 3: The SCP sends a CONNECT with the standard DRA containing B's and the Generic Number contains an NQI value to allow the MSC/SSP to recognize the call needs to support the Ringback Service mechanisms. Details on the special Ringback CONNECT Operation are discussed above.

Step 4: The MSC routes the call to the IP/IVR over ANSI/ETSI ISUP via IAM. The Embedded scfID and corrID should be part of the called party number in any ANSI/ETSI ISUP IAM message. The maximum generic number digit length supported in the CAMEL P2 Connect Operation is 16 digits as per specifications.

Steps 5-6: The IP/IVR sends an ARI to the SCP. The SCP sends a PA to the IP/IVR identifying which personalized Ringback to play. As before, standard CAMEL messages are used in this particular embodiment but any suitable messaging between the IP/IVR and SCP can be used.

Steps 7-8: IP/IVR sends the MSC an ACM [No In-Band-Info; BCIL No Charge] followed by an ANM [BCI: No Charge]. Details on the MSC handling of this message are discussed above.

Steps 9-10: After the ACM/ANM is received from the IP/IVR, the MSC starts the Ringback Delay Timer. When the Ringback delay timer expires, the MSC begins the standard GSM SRI sequence.

At this point, the custom ringtone is playing. Personalized Ringback is played to ‘A’ until ‘B’ answers or the music clip ends. During this time, steps 11 thru 11g occur simultaneously.

Step 11: While the music is playing, the Ringback Delay Timer expires indicating to the MSC to begin the SRI sequence and to continue standard GSM routing the call to the terminator.

Step 11a: SRI for the DRA, which is the ‘B’ party. Following the standard procedure, this SRI query suppresses IN (T-CSI Suppression) that is the HLR will not send back the T-CSI for ‘B’ as it did in the first SRI-ACK.

Step 11b: The HLR sends PRN to the VMSC to get the MSRN for ‘B.’

Step 11c: PRN-ACK is returned with the MSRN for ‘B.’

Step 11d: SRI-ACK with MSRN for ‘B’ is sent to GMSC.

Step 11e: The GMSC routes the call to ‘B’ over ANSI/ETSI ISUP using the MSRN received from the HLR.

Step 11f: The VMSC sends an ACM Alert to the GMSC.

Step 11g: VMSC sends ANM to the GMSC.

Step 12: When Answer has occurred the MSC will release the IP/IVR link, e.g., it sends the IP/IVR an ISUP RELEASE, and bridges the calls so that ‘A’ and ‘B’ are talking. The call then continues as a normal voice call.

Step 13: Party ‘B’ ends the call and the VMSC sends an ISUP Release to the GMSC.

Another embodiment of the present invention implements custom ringback in a GSM network in an in alternate fashion, using the Establish Temporary Connection message (an IN message). This embodiment will now be discussed. The ETC solution may be suitable for Post Paid Subscribers wishing to subscribe to a custom ringback service.

For the Post Paid Custom Ringback service, the MSC will provide the required billing data. Accordingly, the custom Ringback service is not required to monitor the Post Paid IN call once the Calling and Called party have been bridged. For the ETC based solution, once the SCP receives the ‘Empty End’ message, the SCP knows that final answer has occurred and the service has been provided.

For the ANSI market, the Embedded scfID and corrID should be part of the called party number in any ISUP IAM message, or TUP LAI message. It requires inserting a hex digit, such as #B to differentiate the IP routing address and scfID and corrID. The service can insert a DRA2 value in the extension container of the ETC message, such as 123456#123#456. The MSC translations will use 123456 to do the translation to an external IP or IVR. In this example, 123 and 456 will be scfID and corrID address that the external IP or IVR box can use for ARI query to the SCP.

For an ITU/ETSI V3 ISUP link to external IP or IVR, the ETC operation can send down scfID and corrID in explicit format. The ISUP IAM supports the two parameters separately. An embedded format is not required for ITU/ETSI V3 ISUP trunk.

There is a limitation with the ETC method. The service may not be able perform further call monitoring after the calling party and called party are bridged when the service implements the ETC solution. This solution would not be recommended for a PrePaid/Custom Ringback service because it would not permit the MSC to notify the PrePaid service of ‘Disconnect’. Unless these issues are overcome, the ETC solution is best suited for Post Paid IN Ringback services.

FIG. 6 shows an example of the ETC Solution for a terminating Custom Ringback service, where the service instructs the MSC to play the music clip to the Originating party.

Step 1: As before, party A calls party B. The call is routed to the GMSC, where the standard GSM SRI from the MSC to the HLR is sent. The response is SRI-ACK, which returns the ‘B’ Subscriber's CAMEL P2 T-CSI.

Step 2: The MSC triggers Terminating IN at DP12 and sends an InitDP to the SCP.

Step 3: The SCP sends an ETC (Establish Temporary Connection) containing the IP address and the introduced parameter, Destination Routing Address (DRA) containing B's address to allow the MSC/SSP to recognize the call needs to support the Ringback Service mechanisms.

At this point the call flow continues as described for the CONNECT solution, with the IP communicating w/the SCP, the IP sending the ACM/ANM, the MSC playing the ringback tone until the timer expires, then the MSC performing standard terminating GSM and finagling ending the ringback tone upon receipt of Answer from the Terminating party.

While the invention has been described in detail in connection with its application in a Global System for Mobile Communications (GSM)—compliant wireless communications environment, it is to be appreciated and understood that the principles and teachings of the call termination solutions described herein are likewise applicable to wireline environments as well as to wireless communications environments that are compliant with other wireless standards, such as those promulgated by the Third General Partnership Project (“3GPP”), including standards pertaining to wireband CDMA, also known as W-CDMA or UMTS, as well as to wireless standards promulgated by the Third General Partnership Project—2 (“3GPP2”) including the family of cdma2000 standards, such as cdma20001×RTT and cdma20001XEV-DO and -DV, as well as TDMA and other technologies and standards as may come to exist.

Moreover, while the invention has been described in connection with call termination services in the form of audible customizable features provided a call originating party (“caller A”) by the called party (“caller B”), it is to be appreciated that such services could instead be available to such call originator as a function of subscriber services afforded to such call originator through the originator's service provider. Further, while the foregoing call termination services have been described in connection with customizable music offerings, such services need not be limited to musical offerings, and can instead be voice alone, as may occur with the provision of services that provide subscriber with updates to news events, financial news, and the like, or any form of voice in combination with music. Likewise, the call termination services can optionally be in the form of video services, along or in combination with audio, available for receipt by suitably equipped terminals at the appropriate end of the call. Such would permit, for example, the playing of music-video program content in lieu of conventional call termination “ringing” sounds. The provision of a “video” or “multimedia gateway” as depicted in the above description, is one envisioned means of implementing multimedia call termination services.

Moreover, while the invention has been described in connection with call termination services in the form of audible customizable features provided a call originating party (“caller A”) by the called party (“caller B”), it is to be appreciated that such services could instead be available to such call originator as a function of subscriber services afforded to such call originator through the originator's service provider. Further, while the foregoing call termination services have been described in connection with customizable music offerings, such services need not be limited to musical offerings, and can instead be voice alone, as may occur with the provision of services that provide subscriber with updates to news events, financial news, and the like, or any form of voice in combination with music. Likewise, the call termination services can optionally be in the form of video services, along or in combination with audio, available for receipt by suitably equipped terminals at the appropriate end of the call. Such would permit, for example, the playing of music-video program content in lieu of conventional call termination “ringing” sounds. The provision of a “video” or “multimedia gateway” as depicted in the accompanying slides, is one envisioned means of implementing multimedia call termination services.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A method for providing custom ringback in a telecommunications network, the method comprising:
receiving an initiation of a communication between a first party and a second party;
determining a custom ringback feature associated with either the first party or the second party;
connecting an intelligent peripheral to the first party and providing a custom ringback to the first party in accordance with a determined custom ringback feature; and
attempting to connect the first party with the second party while the first party is being provided the custom ringback.

2. The method of claim 1 and further comprising contacting a service control point to determine if either the first party or the second party has subscribed to a custom ringback service.

3. The method of claim 2 wherein determining whether either the first party or the second party has subscribed to a custom ringback service comprises receiving a service flag from a home location register.

4. The method of claim 3 wherein the second party is a wireless telephone subscriber such that determining whether either the first party or the second party has subscribed to a custom ringback service comprises determining that the second party has subscribed to a custom ringback service.

5. The method of claim 1 wherein at least one of the parties is wirelessly connected to the other party to the call.

6. The method of claim 1 wherein the custom ringback comprises a music clip.

7. The method of claim 1 wherein the custom ringback comprises a video clip.

8. The method of claim 1 wherein the custom ringback comprises multimedia content.

9. The method of claim 1 and further comprising connecting the first party with the second party, wherein the custom ringback continues after the first party is connected with the second party.

10. A method of providing a custom ringback service, the method comprising:
receiving a call indication from a caller that is directed to a wireless telephone subscriber;
performing a look-up to a home location register;
receiving a service flag from the home location register, the service flag indicating that the wireless subscriber subscribes to a custom ringback service;
providing information related to the service flag to a service control point;
receiving ringback routing information from the service control point;
initiating a connection between an intelligent peripheral and the caller, the connection being related to the ringback routing information such that a custom ringback is played to the caller; and
attempting to connect the caller to the wireless subscriber.

11. The method of claim 10 wherein receiving ringback routing information comprises receiving a CONNECT message.

12. The method of claim 11 wherein the ringback routing information is embedded in a generic parameter.

13. The method of claim 10 wherein initiating a connection between an intelligent peripheral and the call comprises:
routing a call to the intelligent peripheral using an ISUP message;
receiving an assist request instruction from the intelligent peripheral;
sending a play announcement message to the intelligent peripheral;
receiving an address complete message from the intelligent peripheral.

14. The method of claim 13 wherein the address complete message comprises an ACM [no In-Band Info; BCI: No Charge] message.

15. The method of claim 14 wherein the address complete message comprises ACM [no In-Band Info; BCI: No Charge] message followed by an ANM [BCI: No Charge] message.

16. The method of claim 10 and further comprising waiting a delay time before attempting to connect the caller to the wireless subscriber.

17. A telecommunications system comprising:
a service control point storing information indicating how a telephone call should be handled, the information including information related to a custom ringback service;
an intelligent peripheral having access to at least one custom ringback clip; and
at least one switch communicatively coupled to the service control point and to the intelligent peripheral, the at least one switch configured to route the at least one custom ringback clip from the intelligent peripheral to a caller based upon the information related to a custom ringback service stored in the service control point.

18. The system of claim 17 and further comprising a home location register communicatively coupled to the at least one switch.

19. The system of claim 17 wherein the telecommunications network comprises a network with a wireless air interface.

20. The system of claim 19 wherein the telecommunications network comprises a wireless GSM network.

21. The system of claim 17 wherein the custom ringback clip comprises an audio clip.

22. The system of claim 17 wherein the custom ringback clip comprises a video clip.
